(19) United States
(12) Patent Application Publication
(10) Pub. No.: US 2022/0132754 A1
(43) Pub. Date: May 5, 2022

(54) COMMUNITY INFRASTRUCTURE AND MASTER PLAN FOR PROMOTING THRIVABILITY

(71) Applicant: Peter Lombardi, New York, NY (US)

(72) Inventor: Peter Lombardi, New York, NY (US)

(21) Appl. No.: 17/517,050

(22) Filed: Nov. 2, 2021

Related U.S. Application Data
(60) Provisional application No. 63/109,786, filed on Nov. 4, 2020.

(51) Int. Cl. A01G 23/00; E04H 1/00; E04H 3/00; E04H 5/00; E04H 14/00

(52) U.S. Cl. CPC A01G 23/00; E04H 1/00; E04H 14/00; E04H 5/00; E04H 3/00

(57) ABSTRACT

A master plan for a thrivable community comprises a primary plot of land in the shape of an annulus (ring). The center of the annulus delimits a natural preserve including a body of water, forest, woods, beaches, and combinations thereof. A road or path is provided around the outside of the annulus and a road or path is provided around the interior of the annulus. The community is structured in accordance with the Pareto Principle wherein at most twenty percent (20%) of the area of the community is developed and at least eighty percent (80%) of the area of the community is undeveloped.

### CROSS REFERENCE TO RELATED APPLICATIONS

This application claims the benefit of U.S. Provisional Patent Application No. 63/109,786 filed on Nov. 4, 2020.

### BRIEF DESCRIPTION OF THE DRAWINGS

FIG. 1 is a schematic of the master plan.

It will be recognized that the FIGURE is a schematic representations for purposes of illustration and does not necessarily depict the actual relative sizes or locations of the elements shown.

The FIGURE is provided for the purpose of illustrating one or more embodiments of the invention with the explicit understanding that it will not be used to limit the scope or the meaning of the claims.

### DETAILED DESCRIPTION OF THE INVENTION

In the following description, for the purposes of explanation, numerous specific details are set forth in order to provide a thorough understanding of the holder of the present invention. It will be apparent, however, to one skilled in the art that the holder may be practiced without some of these specific details. Throughout this description, the embodiments and examples shown should be considered as exemplars, rather than as limitations on the holder. That is, the following description provides examples, and the accompanying drawing shows various examples for the purposes of illustration. However, these examples should not be construed in a limiting sense as they are merely intended to provide examples of the holder rather than to provide an exhaustive list of all possible implementations of the holder.

In addition, reference throughout this specification to “some embodiment(s)” or “one embodiment” or “an embodiment” means that a particular feature, structure or characteristic described in connection with the embodiment is included in at least one embodiment of the present invention. Thus, appearances of these phrases in various places throughout this specification are not necessarily all referring to the same embodiment. Furthermore, the particular features, structures or characteristics may be combined in any suitable manner in one or more embodiments.

The present invention comprises various embodiments of a community design and master plan that addresses the need for humanity to build communities in ways that support not only fellow humans, but also plants, animals and entire ecosystems. The present invention solves the current social, economic and environmental crisis through synergy with natural systems and intelligence. The present invention provides a community design and master plan that surpasses the idea or concept of sustainability, which actually only promotes the bare minimum for things to survive. “Thrivability” is a conceptual and physically built system which allows all things to thrive and prosper.

While a community design and master plan is disclosed, the concepts herein can be scaled and applied to a home, a collection of home, a community, or even an entire city. In some embodiments, the present invention utilizes the Pareto Principle (often referred to as the “80/20 rule”) for the organization of properties and the functions within properties, including the community itself, the economy, and the environment. For example, a 1,000 acres site leaves 800 acres untouched and develops only 200 acres. Within the 200 acres, 160 acres are built upon and 40 acres remain public parks. Within the parks, 32 acres are planted and 8 acres are walkways and paths. In some embodiments, 80% of the food grown goes to humans and 20% is given back over to animals and insects. In some embodiments, 80% of the food grown is for community use and 20% of is given to the nearest town or community. In other examples, 80% of the wealth or localized economy goes back to the community participants and 20% goes to the upkeep and reinvestment into community infrastructure and wellbeing. In yet other examples and embodiments, 80% of the land is used by humans and 20% of the land is designed wildlife sanctuary.

Another aspect of some embodiments of the present invention is the use of the golden section or the universal ratio of 1.618. This ratio found throughout the entire universe and even expressed in the human body, is a ratio of harmony and wellness. The ratio of 1.618 is applied not only to the design of the buildings but also to the rooms inside, the layout of the communities, the gardens, and all physical design elements including buildings, paths, gardens, acoustics, and micro environments. The community design and master plan, in some embodiments, uses locally sourced natural materials as much as possible. The layout and positioning of all built elements including homes, buildings, walkways, gardens, public spaces, sports complexes and educational and commercial building are placed to promote strong community and social connection, strong leveraging of natural systems and ease in creating clean water food and energy.

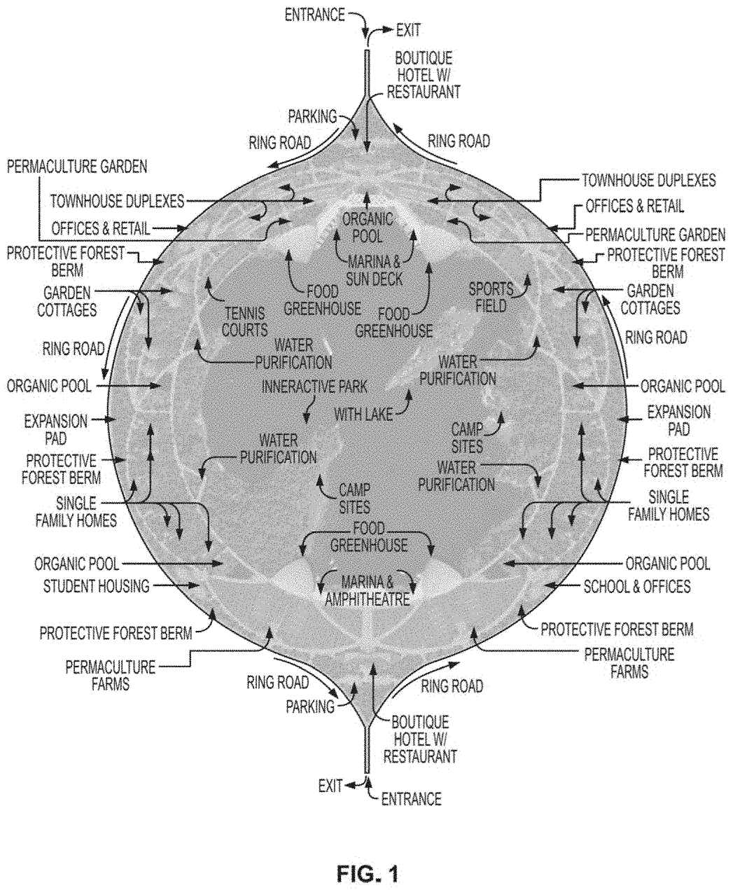

Referring to FIG. 1, shown is one embodiment of the thrivable community design and master plan of the present configured as a 100 acre self-sufficient community. The community is generally configured as a primary plot of land in the shape of an annulus (ring) with the center of annulus delimiting a natural preserve including a body of water, forest, woods, beaches, and combinations thereof. Ingress and egress to the community is provided at the front and back thereof [12 o'clock (north) and 6 o'clock (south) positions]. A perimeter or “ring” road or path is provided around the entirety of the community and various access roads or paths are provided throughout the community “proper” in order to access various locations. In some embodiments, the access roads are configured as symmetrical partial circles, similar in configuration to Borromean rings that are depicted in mathematics. An internal path or road is provided around the inside of the annulus, adjacent to the natural preserve.

The shoreline and/or interior of the natural preserve includes a variety of utilities and functional and recreational facilities including one or more food greenhouses, a marina, an amphitheater, one or more permaculture gardens, sports fields and facilities, camp sites, one or more water purification centers, and one or more interactive parks.

In some embodiments, adjacent to the perimeter or “ring” road is a protective forest berm that forms at least a partial barrier between the community and its surroundings. The primary annulus is where most of the commercial and living facilities are located, for example hotels, townhouse duplexes, cottages, single family home, student housing, offices and retail space, restaurants, community centers, conference centers, and schools. In some embodiments, one or more permaculture farms are located within the community, in one example adjacent to the “south” entrance as shown in FIG. 1. Other features may include microclimates through landscaping and building placement, solar panels, green roofs, underground utilities and waste collection, smart homes, fiberoptic communications, rain water harvesting facilities, and ground source heat pumps.

It is to be noticed that the term “comprising,” used in the claims, should not be interpreted as being limitative to the means listed thereafter. Thus, the scope of the expression “a device comprising means A and B” should not be limited to devices consisting only of components A and B. It means that with respect to the present invention, the only relevant components of the device are A and B. Put differently, the terms “including”, “comprising” and variations thereof mean “including but not limited to”, unless expressly specified otherwise.

The enumerated listing of items does not imply that any or all of the items are mutually exclusive, unless expressly specified otherwise. The terms “a”, “an” and “the” mean “one or more”, unless expressly specified otherwise.

Elements of the invention that are in communication with each other need not be in continuous communication with each other, unless expressly specified otherwise. In addition, elements of the invention that are in communication with each other may communicate directly or indirectly through one or more other elements or other intermediaries.

One skilled in the art will appreciate that the present invention can be practiced by other than the above-described embodiments, which are presented in this description for purposes of illustration and not of limitation. The specification and drawings are not intended to limit the exclusionary scope of this patent document. It is noted that various equivalents for the particular embodiments discussed in this description may practice the invention as well. That is, while the present invention has been described in conjunction with specific embodiments, it is evident that any alternatives, modifications, permutations and variations will become apparent to those of ordinary skill in the art in light of the foregoing description. Accordingly, it is intended that the present invention embrace all such alternatives, modifications and variations as fall within the scope of the appended claims.

What is claimed is:

1. A thrivable community, wherein at most twenty percent (20%) of the area of the community is developed and at least eighty percent (80%) of the area of the community is undeveloped.

2. The community of claim 1, wherein at least twenty percent (20%) of the developed area of the community comprises parks.

3. The community of claim 2, wherein at least eighty percent (80%) of the area of the parks comprises planted land.

4. A thrivable community comprising farmland wherein at most eighty percent (80%) of the farmland is used to grow food for humans with the remaining farmland used to grow food for animals.

5. The thrivable community of claim 4, wherein at most twenty percent (20%) of the area of the community is developed and at least eighty percent (80%) of the area of the community is undeveloped.

6. A thrivable community, comprising:
a primary plot of land in the shape of an annulus (ring), wherein the center of the annulus delimits a natural preserve including a body of water, forest, woods, beaches, and combinations thereof;
a road or path disposed around the outside of the annulus;
a road or path at least partially disposed around the interior of the annulus;
wherein at most twenty percent (20%) of the area of the community is developed and at least eighty percent (80%) of the area of the community is undeveloped.

7. The community of claim 6, wherein at least twenty percent (20%) of the developed area of the community comprises parks.

8. The community of claim 7, wherein at least eighty percent (80%) of the area of the parks comprises planted land.

9. The community of claim 6, wherein the primary plot of land includes farmland whereby at most eighty percent (80%) of the farmland is used to grow food for humans with the remaining farmland used to grow food for animals.
